(19) United States
(12) Patent Application Publication
(10) Pub. No.: US 2005/0120613 A1
(43) Pub. Date: Jun. 9, 2005

(54) Fishing weight

(75) Inventor: Mark Pack, Mineola, TX (US)

Correspondence Address: VENABLE, BAETJER, HOWARD AND CIVILETTI, LLP, P.O. BOX 34385, WASHINGTON, DC, 20043-9998, US

(73) Assignee: Lake Fork Trophy Bait & Tackle, Inc., Emory, TX (US)

(21) Appl. No.: 10/730,039

(22) Filed: Dec. 9, 2003

(51) Int. Cl. A01K 85/00; A01K 95/00

(52) U.S. Cl. 43/42.39; 43/44.9

(57) ABSTRACT

A weight apparatus used with a flexible fishing lure for attachment to a hook attached to a fishing line includes a weight member defining a throughbore. The weight member tapers to a first end and is flattened on a second end. A coil is secured to the second end of the weight member to attach the weight member to the lure.

### BACKGROUND OF THE INVENTION

1. Field of the Invention

The present invention relates generally to a weight for a fishing lure and a method of manufacturing a weight for a fishing lure.

2. Related Art

Bass fishing is a specialty within the broad fishing category of artificial worm fishing using a pole and reel. One popular technique of bass fishing includes casting a lure to a particular spot within a body of water with the lure descending substantially straight downward because of a weight attached to the lure. Once the lure hits bottom, the fisherman then jigs the line so that the lure moves to simulate the movement of a live worm.

The rig most generally associated with this technique of bass fishing comprises a fishing hook having a fishing line attached thereto embedded into and through the front portion of a plastic worm such that the eyelet of the hook remains embedded within the plastic worm. This rig typically utilizes a lead weight at the front of the lure so that when it is cast, the lure descends toward the bottom of the body of water.

To ensure the lure passes freely through aquatic vegetation, a bullet-shaped lead weight having a hole through the center axis thereof is most commonly used. Conventionally, the bullet-shaped weight is attached to the line or to the eyelet of the hook. A thin elongated member, such as a part of a toothpick or a part of a rubber band, is typically used to wedge the fishing line against the interior of the central hole of the lead weight. In U.S. Pat. No. 4,653,212 to Pixton, the weight is attached directly to the lure and is spaced apart from the hook and line. In another lure apparatus, as shown in U.S. Pat. No. 5,129,175 to Pixton, a weight is attached to the lure with an attachment coil. The weight of Pixton '175 requires a tube to be extended through the weight and the attachment coil, and then a fishing line is threaded through the tube.

### SUMMARY OF THE INVENTION

In an exemplary embodiment of the present invention, a weight apparatus for us with a flexible fishing lure and a method of manufacturing the weight apparatus are provided. The weight apparatus includes a weight member defining a throughbore and having a tapered first end and a flattened second end. A wire coil is attached to the second end of the weight member for attachment of the weight member to the lure. The wire coil is free from obstructions such as a tube member.

Further features and advantages of the invention, as well as the structure and operation of various embodiments of the invention, are described in detail below with reference to the accompanying drawings.

### BRIEF DESCRIPTION OF THE DRAWINGS

The foregoing and other features and advantages of the invention will be apparent from the following, more particular description of a preferred embodiment of the invention, as illustrated in the accompanying drawings.

FIG. 1 shows the fishing weight apparatus in accordance with the present invention.

FIG. 2 shows a cross sectional view of the fishing weight apparatus of FIG. 1.

FIG. 3 shows the fishing weight apparatus of FIG. 1 assembled with a fishing line, hook and lure.

### DETAILED DESCRIPTION OF THE PRESENT INVENTION

A preferred embodiment of the invention is discussed in detail below. While specific exemplary embodiments are discussed, it should be understood that this is done for illustration purposes only. A person skilled in the relevant art will recognize that other components and configurations can be used without departing from the spirit and scope of the invention.

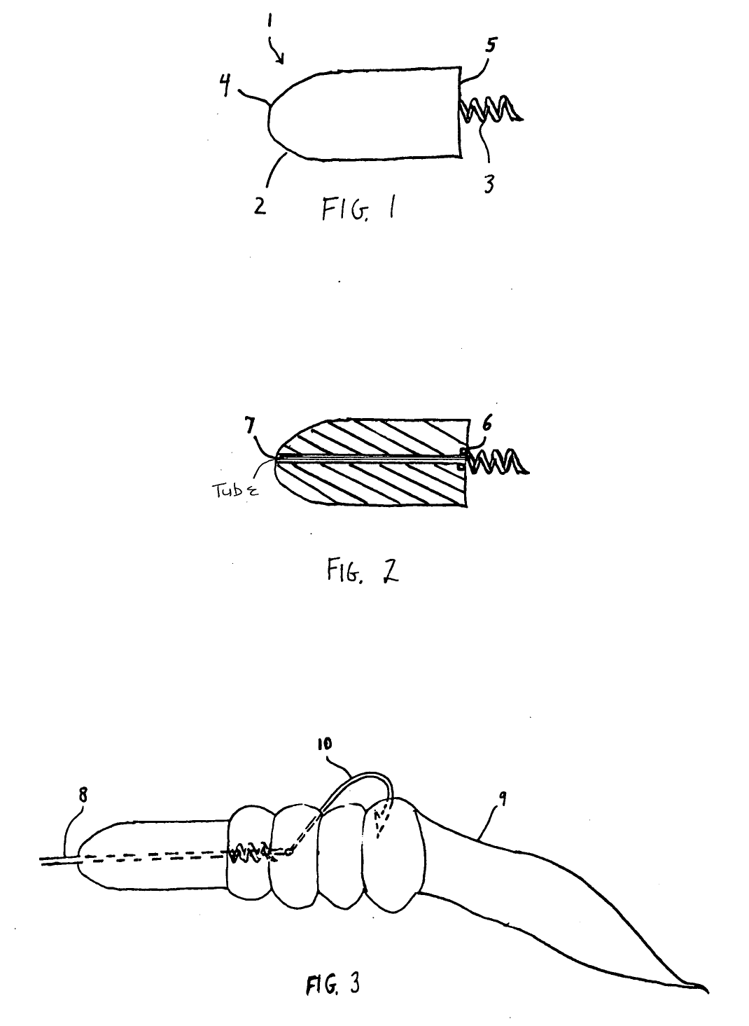

As shown in FIG. 1 and the cross-sectional view of FIG. 2, an exemplary fishing weight apparatus 1 in accordance with the present invention includes a weight member 2 and a mounting assembly 3 for mounting the weight member 2 to a lure (shown in FIG. 3). In one embodiment, the weight member 2 is tungsten. The weight member 2 in the illustrated embodiment has a streamlined design in the shape of a bullet for easy and smooth penetration of a water surface with minimum disturbance. The mounting assembly 3 is shown as a corkscrew, but other arrangements are possible. For example, as an alternative, the mounting assembly 3 can be a hook shape or any assembly suitable for attachment to a lure. The corkscrew mounting assembly 3 of the present invention is advantageously free from obstructions, such as the tube member of Pixton '175. The corkscrew can be a coil, for example, a wire or plastic coil.

As noted above, the weight member 2 is bullet-shaped with a tapered end 4 and a flattened end 5. A throughbore 7 extends longitudinally through the center of the weight member 2. The throughbore 7 can be lined with a tube member, although, the tube member should be flush with the end of the throughbore 7 and not extend into the mounting assembly 3. The flattened end 5 of the weight member 2 has a circular groove 6 coaxial with the throughbore 7. The mounting member 3 can glued in the groove 6. Alternatively, the mounting assembly 3 can be integrally formed with the weight member 2.

FIG. 3 shows the fishing weight apparatus 1 attached to a lure 9 and a fishing line 8. The fishing line 8 is inserted through the throughbore 7 of the weight member 2 and the mounting assembly 3 and then tied to a hook 10. The hook 10 in the exemplary embodiment includes a J-shaped shank that has a barbed portion on one end and an eye for receiving the fishing line on the other end.

The weight assembly 1 is attached to the lure by rotating the corkscrew mounting assembly 3 into the flexible plastic lure. With the corkscrew mounting assembly 3, lure types and sizes can be easily changed with minimum or no damage to the lure.

As can be seen from FIG. 3, the lure 9 has, in the exemplary embodiment, a flat tail that carries considerable less weight than the rest of the lure, particularly when attached to weight member 2. The disposition of the weight at the front end of the lure 9 causes it to point generally downward to more closely resemble a real life worm.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

1: A weight apparatus to be used with a flexible fishing lure for attachment to a hook attached to a fishing line, comprising:
a weight member having a first and second end and a center axis which connects the first and second ends and a throughbore, positioned on the center axis and receives the fishing line, wherein the weight member tapers to the first end and is flat at the second end, which flat second end is perpendicular to the center axis; and
an optional tube within the throughbore, having a first and second tube end, extending from the first weight end to the second weight end and being flush with the flat second end, for receiving the fishing line,
coil means secured to the flat second end of the weight member for attaching the weight member to the lure and for receiving the fishing line, whereby the fishing line is receivable in the throughbore and the coil for attachment to the hook.

2: The weight apparatus according to claim 1, wherein the coil means is a wire coil.

3: The weight apparatus according to claim 1, wherein the second end has a recessed groove coaxial with the throughbore, said coil being glued within said groove.

4: The weight apparatus according to claim 1, wherein the weight member comprises tungsten.

5: The weight apparatus according to claim 1, further comprising the tube.

6: The weight apparatus of claim 1, wherein the weight member is bullet shaped.

7: A method of manufacturing a weight apparatus according to claim 1, comprising:
forming a throughbore in a weight member with a tapered first end and a flat second end; and
securing to the flat second end of the weight member a coil means for attaching the weight member to the lure and for receiving the fishing line.

8: The method according to claim 7, further comprising forming a concentric recessed groove in the flat second end for receiving the coil means and which groove is coaxial with the throughbore, wherein said securing step further includes gluing the coil into the groove.

9: The method according to claim 7, further comprising securing a tube member in the throughbore flush with the end of the throughbore at the second end.

10: The method according to claim 7, wherein the weight member is bullet shaped.

11: A weight apparatus to be used with a flexible fishing lure for attachment to a hook attached to a fishing line, comprising:
a weight member defining a throughbore, wherein the weight member tapers to a first end and is flattened on a second end so that the flatten second end surface is perpendicular to the throughbore; and
a coil secured to the second end of the weight member for attaching the weight member to the lure and for receiving the fishing line, wherein the fishing line extends through and contacts the coil and extends through the throughbore, and wherein the coil does not enclose a tube structure, which is coaxial with the throughbore.
